(19) United States
(12) Patent Application Publication
(10) Pub. No.: US 2007/0219317 A1
(43) Pub. Date: Sep. 20, 2007

(54) Thermoplastic Styrene Resin Composition

(76) Inventor: Masataka Uchikawa, Yokohama (JP)

Correspondence Address: STAAS & HALSEY LLP, SUITE 700, 1201 NEW YORK AVENUE, N.W., WASHINGTON, DC, 20005, US

(21) Appl. No.: 11/578,421

(22) PCT Filed: Apr. 14, 2005
(86) PCT No.: PCT/JP05/07235

§ 371 Date: Oct. 13, 2006

(30) Foreign Application Priority Data
Apr. 15, 2004 (JP) 2004-120405

(51) Int. Cl. C08L 53/00

(52) U.S. Cl. 525/88

(57) ABSTRACT

A thermoplastic resin composition which comprises (A) a rubber-modified styrene resin, (B) a propylene resin, (C) an ethylene-based rubber, and (D) a hydrogenated styrene/conjugated diene block copolymer and satisfies the following relationships: 0<WB/WC<0.9 (formula (1)) and 0.1<(WB+WC)/(WA+WB+WC)<0.5 (formula (2)) [wherein WA represents the weight proportion of the rubber-modified styrene resin (A); WB represents the weight proportion of the propylene resin (B); and WC represents the weight proportion of the ethylene-based rubber (C)].

### TECHNICAL FIELD

The present invention relates to a thermoplastic resin composition excellent in chemical resistance and, particularly, high in high-temperature rigidity and low-temperature impact strength, and a molded article obtained from the composition. Furthermore, the present invention relates to a thermoplastic resin composition excellent in heat stability and suitably usable for various structural materials used in severe environments which require endurance, and a molded article obtained from the composition.

### BACKGROUND ART

As general-purpose resins having well balanced molding processability, impact resistance and rigidity, styrene resins are widely used for various containers, miscellaneous goods such as household products, toys and office supplies, parts of electrical appliances, electric industrial supplies such as housings, residential building materials such as ceilings of bath room and washing and dressing tables. However, styrene resins are inferior in chemical resistance and low-temperature physical properties, and may deteriorate in physical properties upon exposure to heat. For these reasons, styrene resins are restricted in use in such fields as requiring endurance in a wide temperature range, particularly, at low temperatures, such as use for outdoor parts and automobiles.

For improving heat resistance and chemical resistance of styrene resins, various alloys with propylene resins have been disclosed. Recently, certain effects have been attained in inhibition of peeling and in satisfying all of moldability, rigidity and chemical resistance by a method of adding a specific compatibilizer in blending of styrene resins and propylene resins (e.g., Patent Document 1). However, the products obtained by this method are low in impact strength at low temperatures and cannot stand use in severe environments.

For the purpose of improving impact strength of these alloys of styrene resins and propylene resins, it is disclosed to add ethylene rubbers (e.g., Patent Document 2 and Patent Document 3). However, although the resin compositions disclosed in examples of these documents are improved in impact strength at around room temperature, they are still insufficient in impact strength at low temperatures, and are practically unacceptable.

Patent Document 1: JP-A-6-49261

Patent Document 2: JP-A-2000-186177

Patent Document 3: JP-A-2000-212356

### DISCLOSURE OF INVENTION

(Problem to be Solved by the Invention)

Under the circumstances, an object of the present invention is to provide a thermoplastic styrene resin composition which has excellent chemical resistance, elongation characteristics, heat stability, impact strength in a wide temperature range, and endurance in addition to the excellent moldability and rigidity which are inherent to styrene resins, and a molded article obtained from the composition.

(Means for Solving the Problem)

As a result of intensive research conducted by the inventors for attaining the above object, it has been found that a thermoplastic resin composition in which a propylene resin and an ethylene rubber are dispersed at a specific weight ratio in a continuous phase of a styrene resin can attain the above object. Thus, the present invention has been accomplished.

That is, the construction of the present invention is as follows.

(1) A thermoplastic resin composition comprising (A) a rubber-modified styrene resin, (B) a propylene resin, (C) an ethylene rubber, and (D) a hydrogenated styrene-conjugated diene block copolymer, where the hydrogenated styrene-conjugated diene block copolymer (D) is contained in an amount of 5-20 parts by weight based on 100 parts by weight in total of the rubber-modified styrene resin (A), the propylene resin (B), and the ethylene rubber (C); separately from the rubber particles originating from the component (A), the component (B) and the component (C) are dispersed in the styrene resin which is a continuous phase of the component (A); and the components (A), (B) and (C) satisfy the following formulas (1) and (2):
0<WB/WC<0.9 (formula (1)),
and
0.1<(WB+WC)/(WA+WB+WC)<0.5 (formula (2))
(wherein WA represents the weight proportion of the rubber-modified styrene resin (A) in the thermoplastic resin composition, WB represents the weight proportion of the propylene resin (B) in the thermoplastic resin composition, and WC represents the weight proportion of the ethylene rubber (C) in the thermoplastic resin composition).

(2) The thermoplastic resin composition described in (1), wherein the components (A), (B) and (C) satisfy the following formulas (3) and (4):
0.2<WB/WC<0.8 (formula (3)),
and
0.15<(WB+WC)/(WA+WB+WC)<0.35 (formula (4))
(wherein WA represents the weight proportion of the rubber-modified styrene resin (A) in the thermoplastic resin composition, WB represents the weight proportion of the propylene resin (B) in the thermoplastic resin composition, and WC represents the weight proportion of the ethylene rubber (C) in the thermoplastic resin composition).

(3) The thermoplastic resin composition described in (1) or (2), wherein the styrene content in the hydrogenated styrene-conjugated diene block copolymer (D) is 60-80% by weight and the hydrogenation degree is 50% or more.

(4) The thermoplastic resin composition described in any one of (1)-(3), wherein the ethylene rubber (C) is a copolymer of ethylene and an α-olefin of 4-10 carbon atoms.

(5) The thermoplastic resin composition described in any one of (1)-(4), wherein the ethylene rubber (C) is an ethylene-α-olefin copolymer having a density of 0.84-0.91 g/cm³.

(6) The thermoplastic resin composition described in any one of (1)-(5), wherein the rubber-modified styrene resin (A) contains 3-12% by weight of a rubber-like polymer.

(7) The thermoplastic resin composition described in any one of (1)-(6) which has a peak of loss tangent, tan 8 in the range of from −70° C. to −40° C. in measurement of dynamic viscoelasticity.

(8) The thermoplastic resin composition described in any one of (1)-(7), wherein the total amount of styrene monomer and ethylbenzene is 500 ppm or less.

(9) The thermoplastic resin composition described in any one of (1)-(8), wherein the average longer diameter L of the disperse phases comprising the propylene resin (B) and the ethylene rubber (C) is 0.5-10 μm, and the ratio L/D of the average longer diameter L and the average shorter diameter D is 1.1 or more.

(10) The molded article obtained by molding the thermoplastic resin composition described in any one of (1)-(9), wherein the average longer diameter L of the disperse phases comprising the propylene resin (B) and the ethylene rubber (C) is 0.5-10 μm, and the ratio L/D of the average longer diameter L and the average shorter diameter D is 1.1 or more.

In this specification, the term “styrene resin which is a continuous phase of component (A)”(described in the above (1)) means a styrene (co)polymer which is the continuous phase in a case where the portion of “rubber-modified styrene resin”(the component (A)) excluding the rubber particles constitutes the continuous phase in the thermoplastic resin composition. The styrene monomer and the like which are constituents of the styrene (co)polymer will be explained hereinafter.

Advantages of the Invention

The thermoplastic styrene resin composition and molded article obtained from the composition have excellent chemical resistance, elongation characteristics, heat stability, and impact strength in a wide temperature range (particularly in low temperature area) in addition to excellent moldability and rigidity inherent to styrene resins, and furthermore have excellent recycling properties.

### BRIEF DESCRIPTION OF THE DRAWINGS

FIG. 1 is a transmission type electron microscope photograph which shows particle structure of the thermoplastic resin composition of Example 1.

FIG. 2 is a graph which shows absorbed energy curve in falling weight impact test conducted at −30° C. on the test pieces of the thermoplastic resin compositions of Example 1 and Comparative Example 7.

FIG. 3 is a graph of absorbed energy with respect to the ratio WB/WC of the test pieces of the thermoplastic resin compositions of Examples 1-9 and 11, and Comparative Examples 2 and 5-10. Comparative Example 8 corresponds to Example 6 of the above Patent Document 2, Comparative Example 9 corresponds to Example 5 of the above Patent Document 3, and Comparative Example 10 corresponds to Comparative Example 4 of the above Patent Document 3.

FIG. 4 is a graph of critical strain value with respect to the ratio WB/WC of the test pieces of the thermoplastic resin compositions of Examples 1-12, and Comparative Examples 2 and 5-10.

### BEST MODE FOR CARRYING OUT THE INVENTION

The present invention will be explained in detail.

The rubber-modified styrene resin used as the component (A) in the present invention is obtained by copolymerizing styrene monomers or other vinyl monomers copolymerizable with styrene monomers in the presence of a rubber-like polymer, and those which are commercially available can be used.

Examples of the styrene monomers are styrene monomer, and styrene derivative monomers such as p-methylstyrene, α-methylstyrene, p-t-butylstyrene and nuclear-halogenated styrene. These styrene monomers may be used each alone or in admixture of two or more.

Examples of the other vinyl monomers copolymerizable with styrene monomers are acrylonitrile, acrylic acid, methacrylic acid, maleic acid, fumaric acid, maleic anhydride, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, divynylbenzene, etc. These other vinyl monomers may be used each alone or in combination of two or more, and are copolymerized with the styrene monomers in a proportion of 50% by weight or less.

Examples of the rubber-like polymers are polybutadiene rubber, styrene-butadiene rubber, ethylene-propylene rubber (EPR, EPDM), acrylic rubber, nitrile rubber, etc. Polybutadiene rubber or styrene-butadiene rubber is preferred because this can be efficiently graft polymerized with styrene (co)polymers and is easily crosslinked to form particulate rubber particles.

The amount of the rubber-like polymer in the rubber-modified styrene resin is preferably 3-12% by weight. Within this range, tensile elongation, and the better balancing of impact strength and rigidity of the thermoplastic resin composition can be attained. If necessary, a rubber-unmodified styrene resin may be optionally added to the rubber-modified styrene resin used as the component (A) in the present invention. In the case where the rubber-unmodified styrene resin is added, it is preferred to add it so that the amount of the rubber-like polymer based on the total weight of the rubber-modified styrene resin and rubber-unmodified styrene resin is kept within the above range.

The rubber particles in the rubber-modified styrene resin preferably has an area average particle diameter of 0.1-5.0 μm. Within this range, tensile elongation, and the better balancing of gloss and rigidity of the thermoplastic resin composition can be attained. The shape of the rubber particles is not particularly limited, and may be core-shell type or salami type.

The area average particle diameter Ds of the dispersed rubber particles is obtained by taking a transmission type electron microscope photograph of an ultra-thin slice dyed with osmic acid, subjecting 200 or more rubber particles to image analysis, and calculating average of diameters of circles having the same areas as of the respective rubber particles.

Furthermore, the weight average molecular weight Mw of the styrene (co)polymer which is a continuous phase of the thermoplastic resin composition of the present invention is preferably 100,000-500,000.

The polypropylene resins used as the component (B) in the present invention are not particularly limited, and those which are commercially available are used. For example, there may be used homopolymers of propylene, random or block copolymers of propylene with other monomers, etc. These propylene resins may be used each alone or in admixture of two or more.

The ethylene rubbers used as the component (C) in the present invention are ethylene rubbers which are substantially not crosslinked, and there may be used ethylene.propylene copolymer rubbers (EPM), ethylene.propylene.non-conjugated diene copolymer rubbers (EPDM), ethylene-α-olefin copolymers, etc. Of these ethylene rubbers, preferred are ethylene-α-olefin copolymers, and especially preferred are copolymers of α-olefins of 4-10 carbon atoms with ethylene. More preferred are ethylene-α-olefin copolymers having a density of 0.84-0.91 g/cm³. Within this range of density, rigidity and low-temperature impact strength of the resulting thermoplastic resin composition are further well balanced. These ethylene rubbers may be used each alone or in admixture of two or more.

The thermoplastic resin composition of the present invention has a peak of loss tangent, tan δ in the range of from −70° C. to −40° C. in measurement of dynamic viscoelasticity. This peak of tan δ originates from the ethylene rubber (C) and is distinguished from the peak of tan δ at around −100° C. which originates from the rubber particles in the rubber-modified styrene resin. In many cases, the peak of tan δ of the thermoplastic resin composition shifts to the higher temperature side than the peak temperature of the ethylene rubber alone. It is preferred to select the ethylene rubber component which does not cause shifting of the peak temperature of the resulting thermoplastic resin composition to the temperature region of −40° C. or higher. When the thermoplastic resin composition has the peak of tan δ in this range, the better balancing of low-temperature impact strength and high-temperature rigidity of the thermoplastic resin composition can be obtained.

The hydrogenated styrene-conjugated diene block copolymer used as the component (D) in the present invention has at least one polymer block comprising styrene and at least one polymer block mainly composed of conjugated diene compound. Butadiene, isoprene or a mixture thereof is preferably used as the conjugated diene compound. As mentioned hereinafter, the hydrogenated styrene-conjugated diene block copolymer is present at an interface between the rubber-modified styrene resin (A) and the dispersed particles comprising the propylene resin (B) and the ethylene rubber (C) and acts as a compatibilizer. The hydrogenated block copolymer having a styrene content of 40-80% by weight and obtained by hydrogenating 30% or more of double bonds of the conjugated diene block is high in compatibilizing ability and preferred. More preferred is the hydrogenated block copolymer having a styrene content of 60-80% by weight and obtained by hydrogenating 50% or more of double bonds of the conjugated diene block.

It is necessary that the components (A), (B) and (C) in the thermoplastic resin composition of the present invention satisfy the following formula (1) and formula (2):
0<WB/WC<0.9 (formula (1))
0.1<(WB+WC)/(WA+WB+WC)<0.5 (formula (2))
(wherein WA represents the weight proportion of the rubber-modified styrene resin (A) in the thermoplastic resin composition, WB represents the weight proportion of the propylene resin (B) in the thermoplastic resin composition, and WC represents the weight proportion of the ethylene rubber (C) in the thermoplastic resin composition).

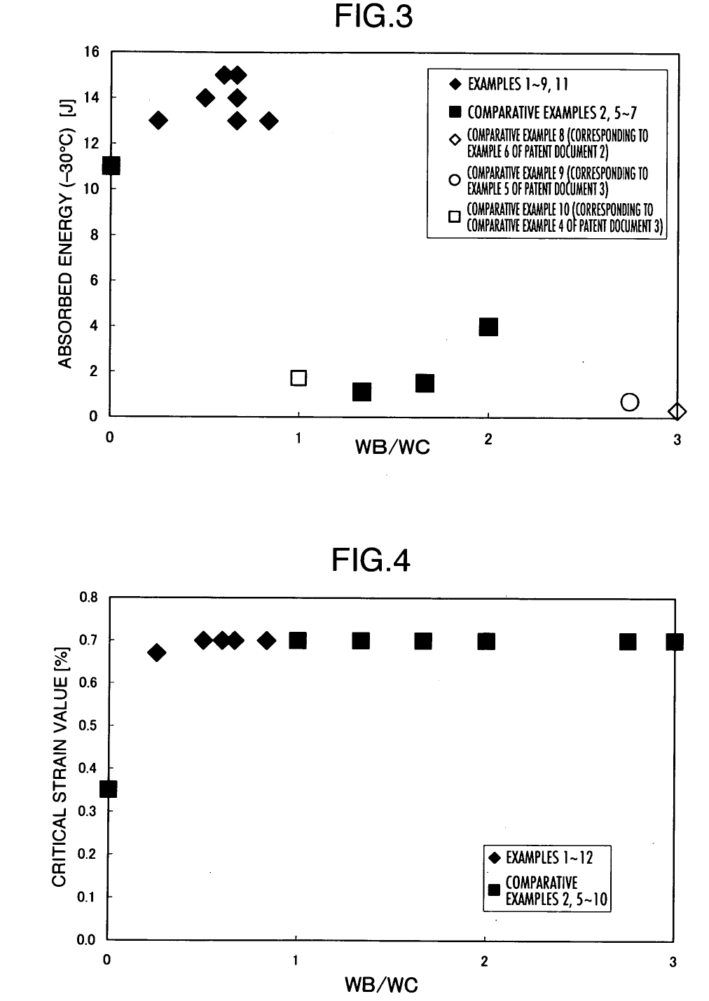

The formula (1) shows that the weight proportion of the ethylene rubber (C) is higher than that of the propylene resin (B). The formula (1) is preferably 0.1<WB/WC<0.9, more preferably 0.2<WB/WC<0.8. If the ratio WB/WC is higher than 0.9, the thermoplastic resin composition is inferior in low-temperature temperature impact strength. As mentioned hereinafter, FIG. 3 shows the relation in plotting between the ratio WB/WC in the thermoplastic resin composition and the absorbed energy in the falling weight impact test at −30° C. on the thermoplastic resin compositions in Examples and Comparative Examples. From the relation, it has been found that surprisingly the absorbed energy value at −30° C. abruptly changes at around WB/WC=1. On the other hand, the thermoplastic resin composition is inferior in chemical resistance at around WB/WC=0. Furthermore, as mentioned hereinafter, FIG. 4 shows the relation between the ratio WB/WC in the thermoplastic resin composition and the critical strain of the thermoplastic resin composition in Examples and Comparative Examples of the present invention. From this relation, it has been recognized that when the propylene resin (B) is not present, the critical strain value is low, and the critical strain value sharply increases only by the addition of the component (B) in a small amount to result in improvement of the chemical resistance.

The formula (2) shows the weight proportion of the component (B) and the component (C) based on the total weight of the components (A), (B) and (C), and is preferably 0.15<(WB+WC)/(WA+WB+WC)<0.4, more preferably 0.15<(WB+WC)/(WA+WB+WC)<0.35. If the ratio (WB+WC)/(WA+WB+WC) exceeds 0.5, the resulting thermoplastic resin composition is insufficient in rigidity, particularly high-temperature rigidity. If the ratio (WB+WC)/(WA+WB+WC) is lower than 0.1, the resulting thermoplastic resin composition is insufficient in low-temperature impact strength.

The amount of the hydrogenated styrene-conjugated diene block copolymer (D) in the thermoplastic resin composition of the present invention is 5-20 parts by weight, more preferably 7-15 parts by weight based on 100 parts by weight of the components (A), (B) and (C) in total. If the amount of the component (D) is less than 5 parts by weight, compatibilization of the resulting thermoplastic resin composition is not sufficient, and the composition is inferior in physical properties such as impact strength and tensile elongation. If the amount of the component (D) exceeds 20 parts by weight, rigidity of the thermoplastic resin composition is deteriorated.

In the thermoplastic resin composition of the present invention, the propylene resin (B) and the ethylene rubber component (C) are present as disperse phases in the styrene resin which is a continuous phase of the rubber-modified styrene resin (A) separately from the rubber particles originating from the component (A). The average longer diameter L of the disperse phases comprising the propylene resin (B) and the ethylene rubber (C) in the thermoplastic resin composition of the present invention is preferably 0.5-10 μm. When the average longer diameter L is within the above range, the thermoplastic resin composition is particularly satisfactory in low-temperature impact strength. The average longer diameter is more preferably 1-5 μm.

It is preferred that the disperse phases comprising the propylene resin (B) and the ethylene rubber (C) are in the flat form, and the ratio L/D of the average longer diameter L and the average shorter diameter D is 1.1 or more. When the ratio L/D is 1.1 or more, the thermoplastic resin composition is further improved in low-temperature impact strength, and, besides, is also improved in hinging performance. The ratio L/D of 1.5 or more is more preferred.

L and L/D are obtained in the following manner. An ultra-thin slice of the thermoplastic resin composition (pellet or molded article) dyed first with osmium tetroxide and then with ruthenium tetroxide is photographed by a transmission type electron microscope. The rubber component in the rubber-modified styrene resin and the disperse phases of the propylene resin and the ethylene rubber can be distinguished by the depth (degree) of dyeing. In the transmission type electron microscope photograph, the longer diameter and the shorter diameter of 200 or more disperse phases excluding the rubber particles originating from the rubber-modified styrene resin are measured, and the longer diameters and the shorter diameters obtained are averaged, respectively, and L and L/D are obtained.

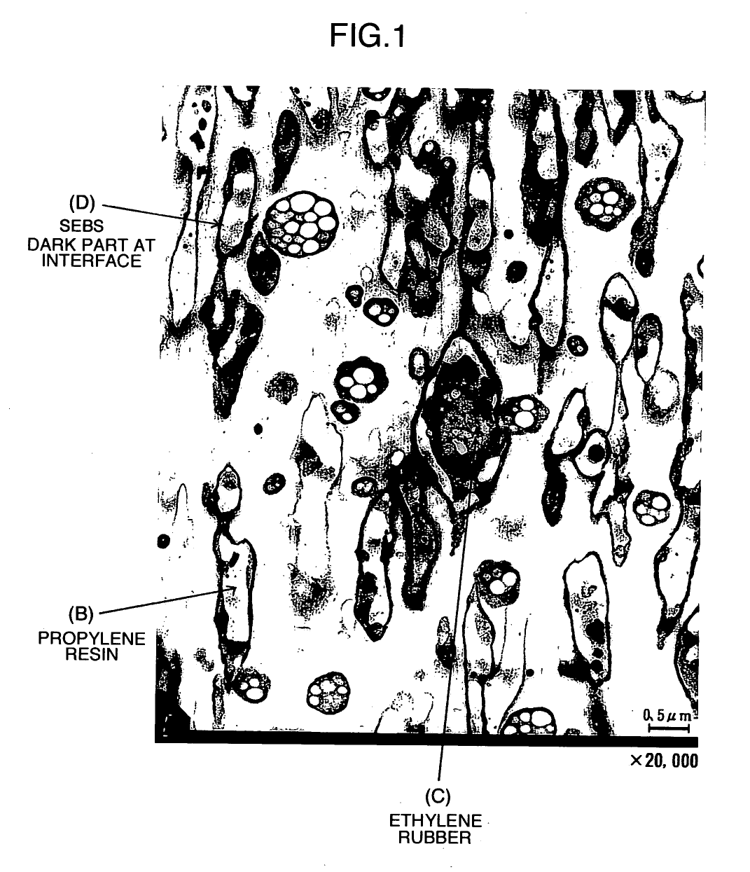

FIG. 1 shows a transmission type electron microscope photograph of an ultra-thin slice (80 nm thick) of pellets of Example 1 dyed with osmium tetroxide and then with ruthenium tetroxide. Fine and flat disperse phases having light and shade distribution are observed separately from the crosslinked rubber particles (in the form of salami) originating from the rubber-modified styrene resin in the styrene resin which is a continuous phase of the component (A) of the thermoplastic resin composition of the present invention. The disperse phases which are lighter are of the propylene resin and the disperse phases which are darker are of the ethylene rubber, and there are formed disperse phases of the propylene resin and the ethylene rubber which are present together in the same particles. The reason for the disperse phases being flat is that the propylene resin and the ethylene rubber used in the present invention are not crosslinked. The part seen dark at the interface between the disperse phase and the continuous phase is the hydrogenated styrene-conjugated diene block copolymer.

The total amount of styrene monomer and ethylbenzene in the thermoplastic resin composition of the present invention is preferably 500 ppm or less. When the total amount of styrene monomer and ethylbenzene is 500 ppm or less, there are many advantages such as inhibition of drawdown which may occur during extrusion molding or blow molding. The total amount can be controlled by selecting as the component (A) a rubber-modified styrene resin smaller in residual amounts of styrene monomer and ethylbenzene and/or carrying out deaeration by a vented extruder at the time of kneading.

As mentioned above, as long as the formulas (1) and (2) are satisfied, the proportion of the components (A), (B) and (C) is not particularly specified, and from the viewpoint of balancing of rigidity, chemical resistance, heat resistance and impact strength of the thermoplastic resin composition, preferred are 50-90 parts by weight of the styrene resin (A), 5-20 parts by weight of the propylene resin (B), and 8-30 parts by weight of the ethylene rubber (C).

The thermoplastic resin composition of the present invention may optionally contain various additives, for example, phenolic or phosphorus antioxidants, plasticizers such as liquid paraffin, releasing agents such as stearic acid, zinc stearate and calcium stearate, external lubricants such as ethylenebisstearylamide, various pigments, flame retardants, silicone oil, etc.

The method for producing the thermoplastic resin composition of the present invention is not particularly limited, and known methods can be employed. For example, it is produced by using known kneaders such as single screw extruders, twin-screw extruders and Banbury mixers.

The thermoplastic resin composition of the present invention is molded by known molding methods such as injection molding, extrusion molding, thermoforming, hollow molding, blow molding and expansion molding, and if necessary, the products can be subjected to antistatic treatment, painting, plating, etc.

### EXAMPLES

The present invention will be specifically explained by the following examples, which should not be construed as limiting the invention.

(1) Components Used

(A) Rubber-Modified Styrene Resins

High-impact polystyrene (HIPS): Trade name “HT478” (manufactured by PS Japan Corporation; dispersed rubber particle diameter =1.8 μm)

Polystyrene resin (GPPS): Trade name “685” (manufactured by PS Japan Corporation; used for dilution)

Polystyrene resin (GPPS): Trade name “680” (manufactured by PS Japan Corporation; used for dilution)

(B) Propylene Resins

Homo-polypropylene resin: Trade name “EA9” (manufactured by Japan Polypropylene Corporation)

Block-polypropylene resin: Trade name “EC9” (manufactured by Japan Polypropylene Corporation)

(C) Ethylene Rubbers

Polyethylene: Trade name “KS240T” (manufactured by Japan Polyethylene Corporation; density =0.880 g/cm³)

Ethylene-α-olefin copolymer: Trade name “EG8100” (manufactured by DuPont Dow Elastomers Japan K.K.; density =0.870 g/cm³)

Ethylene-α-olefin copolymer: Trade name “EBM3011P” (manufactured by JSR Corporation; density =0.860 g/cm³)

Ethylene-α-olefin copolymer: Trade name “MORETEC 0138” (manufactured by Idemitsu Petrochemical Co., Ltd.; density =0.917 g/cm³)

(D) Hydrogenated styrene-conjugated diene block copolymers

SEBS: Trade name “H1043” (manufactured by Asahi Kasei Chemicals Corporation; styrene content =65% by weight, hydrogenation degree >90%)

SEBS: Trade name “H1041” (manufactured by Asahi Kasei Chemicals Corporation; styrene content =30% by weight, hydrogenation degree >90%)

SEPS: Trade name “S2104” (manufactured by Kuraray Co., Ltd.; styrene content =65% by weight, hydrogenation degree >90%)

(2) Test Methods

Average longer diameter L, L/D:

L and L/D are obtained in the following manner. A flat plate of 2.0 mm in thickness made by injection molding the pellets of the thermoplastic resin composition is dyed with osmium tetroxide and then with ruthenium tetroxide. An ultra-thin slice of 80 nm in thickness cut out from the dyed molded article is photographed by a transmission type electron microscope. In the transmission type electron microscope photograph, the longer diameter and the shorter diameter of 200 or more disperse phases excluding the rubber particles originating from the rubber-modified styrene resin are measured, and the longer diameters and the shorter diameters obtained are averaged, respectively, and L, D and L/D are obtained (only L and L/D are shown in Table 1 and Table 2 given hereinafter).

Loss Tangent, tan δ

In accordance with ISO6721-2, a strip (about 2 mm×12.5 mm×62 mm in size) is prepared from pellets of the thermoplastic resin composition by press molding, and the loss tangent, tan δ is measured using RMS-800 of Rheometric Scientific, Inc. at a cooling rate of 3° C./min and a frequency of 10 rad/s in nitrogen.

Flexural Modulus:

This is measured at a measuring temperature of 60° C. in accordance with ISO178.

Falling Weight Impact Test:

In accordance with ISO6603-2, a test piece (a flat plate of 2.0 mm in thickness) is prepared from pellets of the thermoplastic resin composition, and an absorbed energy (J) of the test piece is measured using IFW manufactured by Rosand Co., Ltd., at a missile diameter of 10 mm, a missile weight of 3.2 kg, a falling height of 1 m and a testing temperature of −30° C., 23° C. or 60° C.

Chemical Resistance:

A critical strain is obtained in accordance with a method (Bending Form Method) disclosed in “Materials Research & Standards”, Vol.9, No.12, p32.

First, a test piece of 1-2 mm in thickness, 35 mm in width, 230 mm in length is prepared from pellets of the thermoplastic resin composition by a compression molding method (press molding). The test piece is fixed on a bending form in which strain is continuously changed from 0 to 0.85%, coated with kerosene, and left to stand for 17 hours at 23° C. and 50% RH. Then, the test piece is taken out, and the distance from the cardinal point to a point (a position) at which crack occurs is measured, and the critical strain value (%) is obtained. The greater critical strain value shows the higher chemical resistance. However, since adhesion of the test piece to the bending form jig on the higher strain side is inferior, and the precision is lower, the test piece of which critical strain value exceeds 0.7% is indicated by “>0.7%” in Tables 1-3.

Quantitative determination of styrene monomer and ethylbenzene:

Pellets of the thermoplastic resin composition are ground and subjected to Soxhlet extraction with methyl ethyl ketone for 8 hours, followed by re-precipitation with methanol and filtration to remove the polymer components. The filtrate is concentrated, and quantitative determination of styrene monomer and ethylbenzene is carried out by gas chromatography (ppm by weight of each of components in the molded article).

### Example 1

60 parts by weight of HIPS (trade name “HT478” manufactured by PS Japan Corporation) and 15 parts by weight of GPPS (trade name “685” manufactured by PS Japan Corporation) as the component (A), 10 parts by weight of a block polypropylene resin (trade name “EC9” manufactured by Japan Polypropylene Corporation) as the component (B), and 15 parts by weight of an ethylene-α-olefin copolymer (trade name “EG8100” manufactured by DuPont Dow Elastomers Japan K.K.) as the component (C), and SEBS (trade name “H1043” manufactured by Asahi Kasei Chemicals Corporation) in an amount of 8 parts by weight based on 100 parts by weight in total of the components (A), (B) and (C) were blended for preparing pellets. Then, the resulting blend was kneaded using a twin-screw extruder (TEM35 manufactured by Toshiba Machine Co., Ltd.) at a cylinder temperature of 220° C. and a screw revolution number of 200 rpm with a vacuum vent to prepare pellets.

Various test pieces were prepared by injection molding (or compression molding) the pellets, and subjected to various evaluations on physical properties.

Furthermore, an operation of kneading the pellets using a counter-rotation twin-screw extruder (AS30 manufactured by Nakatani Machinery Co., Ltd.) at 230° C. and then re-pelletizing the kneaded product was carried out repeatedly eight times to obtain pellets exposed to heat history. The results of the falling weight impact test (measurement of absorbed energy) conducted by the above method at −30° C. on the pellets after extruded eight times are shown in Table 1.

### Examples 2-10

Pellets were prepared in the same manner as in Example 1, except that the kinds and proportions of the components (A)-(D) were changed as shown in Table 1, and various evaluations were conducted. The results of measurement of various physical properties are shown in Table 1.

### Example 11

Pellets were prepared at the same compositions as in Example 1 at an extrusion temperature of 250° C. by carrying out the kneading without using vacuum vent. The results of measurement of various physical properties are shown in Table 1.

### Example 12

Various test pieces were prepared by compression molding using the pellets prepared in Example 1, and the evaluations were conducted. The results of measurement of various physical properties are shown in Table 1.

### Comparative Examples 1-10

Pellets were prepared in the same manner as in Example 1, except that the kinds and proportions of the components (A)-(D) were changed as shown in Table 2, and the evaluations of various physical properties were conducted. However, since initial characteristics before recycling (low-temperature impact strength, high-temperature rigidity) or chemical resistance were inferior in Comparative Examples 1-10, the recycling physical properties (absorbed energy of pellets after extruded eight times) were not measured. The results of measurement of various-physical properties are shown in Table 2.

### Reference Example 1

A resin composition was obtained in the same manner as in Example 1, except that a styrene-conjugated diene block elastomer (SB block elastomer)(trade name “TR125” manufactured by Asahi Kasei Corporation) was used in place of the component (C). The results of measurement of various physical properties are shown in Table 3.

As can be seen from Table 1, the thermoplastic resin compositions of the present invention in Examples 1-12 were excellent in impact resistance and rigidity in a wide temperature range of from low temperature of −30° C. to high temperature of 60° C., less in deterioration of physical properties after repeated extrusion, and excellent in chemical resistance.

The results of Table 2 show the followings. If the thermoplastic resin composition did not contain the ethylene rubber (C), it was inferior in low-temperature impact strength, resulting in brittle fracture (Comparative Example 1). On the other hand, if the thermoplastic resin composition did not contain the propylene resin (B), it was inferior in chemical resistance (Comparative Example 2). The thermoplastic resin composition of Comparative Example 3 containing the propylene resin (B) in a larger amount did not satisfy the formula (1) and the formula (2), and was inferior in high-temperature rigidity and impact strength, though it was excellent in chemical resistance. If only a styrene resin which was not modified with rubber was used (Comparative Example 4), the thermoplastic resin composition was inferior in low-temperature impact strength, resulting in brittle fracture. If the thermoplastic resin compositions did not satisfy the formula (1) as in Comparative Examples 5-10, they were inferior in low-temperature impact strength, which led to brittle fracture.

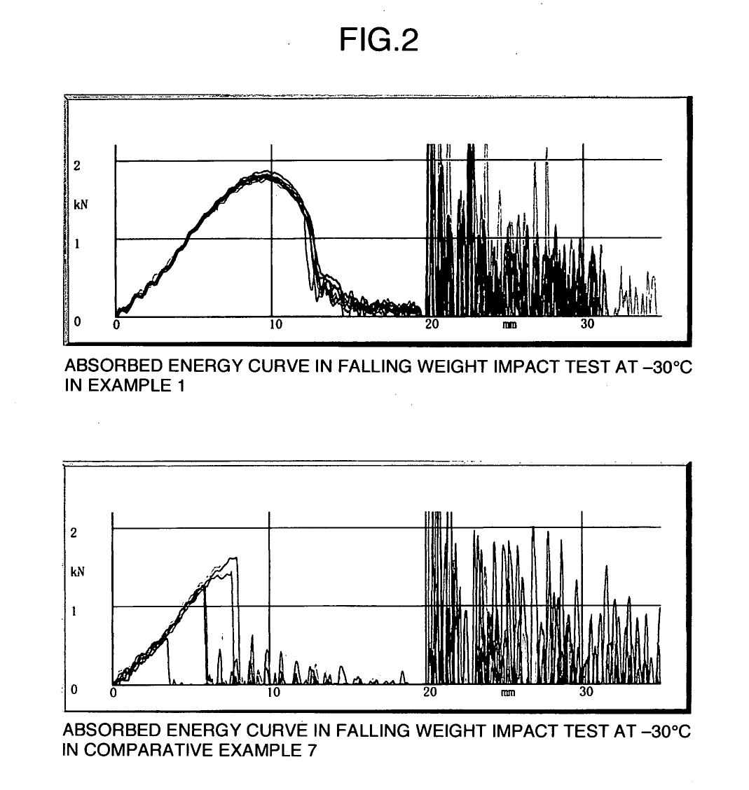

FIG. 2 shows an absorbed energy curve obtained in the falling weight impact test conducted at −30° C. on the test pieces of the thermoplastic resin compositions of Example 1 and Comparative Example 7, in which the horizontal axis shows displacement (unit: mm) and the ordinate axis shows stress (unit: kN). In Example 1, the maximum stress was high and there occurred ductile fracture which involved deformation until the striker penetrated the test piece, while in Comparative Example 7 in which the formula (1) was not satisfied, the stress sharply dropped at the fracture point, which showed typical brittle fracture behavior.

FIG. 3 is a graph in which absorbed energy in the falling weight impact test at −30° C. is plotted against the ratio WB/WC on the test pieces of Examples 1-9 and 11 and Comparative Examples 2 and 5-10. The test pieces of the thermoplastic resin compositions in Examples of the present invention showed high absorbed energy even under the severe condition of −30° C. On the other hand, it is clear that the test pieces of the thermoplastic resin compositions in the Comparative Examples were low in absorbed energy value and were inferior. Surprisingly, it is seen from FIG. 3 that the absorbed energy value of the test pieces of the thermoplastic resin compositions abruptly changed at around WB/WC=1. Comparative Example 8 corresponds to Example 6 of the above Patent Document 2, Comparative Example 9 corresponds to Example 5 of the above Patent Document 3, and Comparative Example 10 corresponds to Comparative Example 4 of the above Patent Document 3.

FIG. 4 is a graph in which critical strain is plotted against the ratio WB/WC on the test pieces of Examples 1-12 and Comparative Examples 2 and 5-10. It can be seen from the resulting relation that when the propylene resin (B) was not present, the critical strain value was low and it sharply increased only by adding a small amount of the component (B), and chemical resistance was improved. In FIG. 4, when the critical strain value is >0.7% as mentioned above, the points of 0.7 were plotted.

Furthermore, it can be seen from Table 3 that in the case of the thermoplastic resin composition in which a styrene-butadiene elastomer was used in place of the ethylene rubber which was the component (C) as in Reference Example 1, the deterioration of physical properties after repeated extrusion was noticeable.

TABLE 1

| Component | Trade name | Example 1 | Example 2 | Example 3 | Example 4 | Example 5 |
|---|---|---|---|---|---|---|
| (A) Rubber-modified | HT478 | 60 | 60 | 50 | 60 | 60 |
| styrene resin | (weight part) | | | | | |
| | 685 | 15 | 25 | 10 | 15 | 18 |
| | (weight part) | | | | | |
| | 680 | — | — | — | — | — |
| | (weight part) | | | | | |
| (B) Propylene resin | EC9 | 10 | 5 | 15 | 5 | 10 |
| | (weight part) | | | | | |
| | EA9 | — | — | — | — | — |
| | (weight part) | | | | | |
| (C) Ethylene rubber | EG8100 | 15 | 10 | 25 | 20 | 12 |
| | (weight part) | | | | | |
| | KS240T | — | — | — | — | — |
| | (weight part) | | | | | |
| | EBM3011P | — | — | — | — | — |
| | (weight part) | | | | | |
| (D) Hydrogenated styrene- | H1043 | 8 | 7 | 10 | 8 | 8 |
| conjugated diene block | (weight part) | | | | | |
| copolymer | S2104 | — | — | — | — | — |
| | (weight part) | | | | | |
| | H1041 | — | — | — | — | — |
| | (weight part) | | | | | |
| WB/WC | | 0.67 | 0.50 | 0.60 | 0.25 | 0.83 |
| (WB + WC)/(WA + WB + WC) | | 0.25 | 0.15 | 0.40 | 0.25 | 0.22 |
| Peak of tan δ between −70° C. to −40° C. [° C.] | | −48 | −48 | −48 | −48 | −48 |
| Average longer diameter L [μm] | | 1.7 | 1.6 | 1.3 | 1.7 | 1.5 |
| L/D [−] | | 3.1 | 2.9 | 2.8 | 3.3 | 2.9 |
| Total amount of styrene monomer and ethylbenzene | | 300 | 350 | 450 | 300 | 350 |
| in the resin composition [weight ppm] | | | | | | |
| Flexural modulus [MPa] | 60° C. | 1400 | 1500 | 1200 | 1400 | 1600 |
| Absorbed energy [J] | −30° C. | 15 | 14 | 15 | 13 | 13 |
| | 23° C. | 12 | 12 | 12 | 10 | 10 |
| | 60° C. | 11 | 11 | 10 | 7 | 9 |
| | Mode of fracture | Ductile | Ductile | Ductile | Ductile | Ductile |
| | at −30° C. | fracture | fracture | fracture | fracture | fracture |
| Absorbed energy after | −30° C. | 14 | 12 | 14 | 13 | 12 |
| extrusion of 8 times [J] | Mode of fracture | Ductile | Ductile | Ductile | Ductile | Ductile |
| | | fracture | fracture | fracture | fracture | fracture |
| Critical strain value [%] | Kerosine | >0.7 | >0.7 | >0.7 | 0.67 | >0.7 |

| | | Example | Example | Example | Example | Example | Example | Example |
|---|---|---|---|---|---|---|---|---|
| Component | Trade name | 6 | 7 | 8 | 9 | 10 | 11 | 12 |
| (A) Rubber-modified | HT478 | 60 | 60 | 60 | 60 | 60 | 60 | 60 |
| styrene resin | (weight part) | | | | | | | |
| | 685 | 15 | 15 | 15 | 15 | 15 | 15 | 15 |
| | (weight part) | | | | | | | |
| | 680 | — | — | — | — | — | — | — |
| | (weight part) | | | | | | | |
| (B) Propylene resin | EC9 | 10 | 10 | 10 | — | — | 10 | 10 |
| | (weight part) | | | | | | | |
| | EA9 | — | — | — | 10 | 10 | — | — |
| | (weight part) | | | | | | | |
| (C) Ethylene rubber | EG8100 | — | — | 15 | 15 | 15 | 15 | 15 |
| | (weight part) | | | | | | | |
| | KS240T | 15 | — | — | — | — | — | — |
| | (weight part) | | | | | | | |
| | EBM3011P | — | 15 | — | — | — | — | — |
| | (weight part) | | | | | | | |
| (D) Hydrogenated styrene- | H1043 | 8 | 8 | — | 8 | — | 8 | 8 |
| conjugated diene block | (weight part) | | | | | | | |
| copolymer | S2104 | — | — | 8 | — | — | — | — |
| | (weight part) | | | | | | | |
| | H1041 | — | — | — | — | 8 | — | — |
| | (weight part) | | | | | | | |
| WB/WC | | 0.67 | 0.67 | 0.67 | 0.67 | 0.67 | 0.67 | 0.67 |
| (WB + WC)/(WA + WB + WC) | | 0.25 | 0.25 | 0.25 | 0.25 | 0.25 | 0.25 | 0.25 |
| Peak of tan δ between −70° C. to −40° C. [° C.] | | −43 | −53 | −48 | −48 | −48 | −48 | −48 |
| Average longer diameter L [μm] | | 1.7 | 1.6 | 1.7 | 1.9 | 2.3 | 1.6 | 0.6 |
| L/D [−] | | 3.1 | 3.0 | 3.0 | 3.3 | 3.9 | 3.0 | 1.1 |
| Total amount of styrene monomer and ethylbenzene | | 300 | 300 | 300 | 300 | 300 | 1500 | 300 |
| in the resin composition [weight ppm] | | | | | | | | |
| Flexural modulus [MPa] | 60° C. | 1400 | 1400 | 1400 | 1400 | 1300 | 1100 | 1500 |
| Absorbed energy [J] | −30° C. | 13 | 15 | 15 | 13 | 11 | 14 | 10 |
| | 23° C. | 12 | 12 | 12 | 13 | 9 | 10 | 10 |
| | 60° C. | 11 | 11 | 11 | 11 | 8 | 7 | 9 |
| | Mode of fracture | Ductile | Ductile | Ductile | Ductile | Ductile | Ductile | Ductile |
| | at −30° C. | fracture | fracture | fracture | fracture | fracture | fracture | fracture |
| Absorbed energy after | −30° C. | 13 | 13 | 14 | 13 | 10 | 11 | 9 |
| extrusion of 8 times [J] | Mode of fracture | Ductile | Ductile | Ductile | Ductile | Ductile | Ductile | Ductile |
| | | fracture | fracture | fracture | fracture | fracture | fracture | fracture |
| Critical strain value [%] | Kerosine | >0.7 | >0.7 | >0.7 | >0.7 | >0.7 | >0.7 | >0.7 |

TABLE 2

| | | Comparative | Comparative | Comparative | Comparative |
|---|---|---|---|---|---|
| Component | Trade name | Example 1 | Example 2 | Example 3 | Example 4 |
| (A) Rubber-modified | HT478 (weight part) | 70 | 67 | 15 | — |
| styrene resin | 685 (weight part) | 18 | 16 | 10 | 75 |
| (B) Propylene resin | EC9 (weight part) | 12 | — | 60 | 10 |
| (C) Ethylene rubber | EG8100 (weight part) | — | 17 | 15 | 15 |
| | MORETEC0138 | — | — | — | — |
| | (weight part) | | | | |
| (D) Hydrogenated | H1043 | 8 | 8 | 10 | 8 |
| styrene-conjugated | (weight part) | | | | |
| diene block copolymer | | | | | |
| WB/WC | | — | 0.00 | 4.00 | 0.67 |
| (WB + WC)/(WA + WB + WC) | | 0.12 | 0.17 | 0.75 | 0.25 |
| Peak of tan δ between −70° C. | | no | −48 | −48 | −53 |
| to −40° C. [° C.] | | | | | |
| Average longer diameter L [μm] | | 1.6 | 1.7 | 1.5 | 1.7 |
| L/D [−] | | 2.9 | 3.0 | 2.5 | 3.1 |
| Total amount of styrene monomer and ethylbenzene | | 400 | 450 | 90 | 300 |
| in the resin composition [weight ppm] | | | | | |
| Flexural modulus | 60° C. | 1400 | 1300 | 700 | 1500 |
| [MPa] | | | | | |
| Absorbed energy | −30° C. | 0.4 | 11 | 12 | 4 |
| [J] | 23° C. | 6 | 12 | 12 | 12 |
| | 60° C. | 11 | 11 | 7 | 11 |
| | Mode of fracture | Brittle | Brittle | Brittle | Brittle |
| | at −30° C. | fracture | fracture | fracture | fracture |
| Critical strain | Kerosine | >0.7 | 0.35 | >0.7 | >0.7 |
| value [%] | | | | | |

| | | Comparative | Comparative | Comparative | Comparative | Comparative | Comparative |
|---|---|---|---|---|---|---|---|
| Component | Trade name | Example 5 | Example 6 | Example 7 | Example 8 | Example 9 | Example 10 |
| (A) Rubber-modified | HT478 (weight part) | 56 | 50 | 56 | 20 | 40 | 40 |
| styrene resin | 685 (weight part) | 14 | 10 | 14 | 50 | 30 | 30 |
| (B) Propylene resin | EC9 (weight part) | 20 | 25 | 20 | 30 | 22 | 15 |
| (C) Ethylene rubber | EG8100 (weight part) | 15 | 15 | 10 | 10 | 8 | — |
| | MORETEC0138 | — | — | — | — | — | 15 |
| | (weight part) | | | | | | |
| (D) Hydrogenated | H1043 | 8 | 8 | 10 | 10 | 4 | 4 |
| styrene-conjugated | (weight part) | | | | | | |
| diene block copolymer | | | | | | | |
| WB/WC | | 1.33 | 1.67 | 2.00 | 3.00 | 2.75 | 1.00 |
| (WB + WC)/(WA + WB + WC) | | 0.33 | 0.40 | 0.30 | 0.36 | 0.30 | 0.30 |
| Peak of tan δ between −70° C. | | −46 | −43 | −46 | −46 | −45 | no |
| to −40° C. [° C.] | | | | | | | |
| Average longer diameter L [μm] | | 1.8 | 1.9 | 1.8 | 1.9 | 2.5 | 2.3 |
| L/D [−] | | 3.0 | 2.9 | 3.2 | 2.5 | 2.7 | 2.5 |
| Total amount of styrene monomer and ethylbenzene | | 260 | 210 | 250 | 230 | 250 | 260 |
| in the resin composition [weight ppm] | | | | | | | |
| Flexural modulus | 60° C. | 1200 | 1100 | 1200 | 1100 | 1200 | 1100 |
| [MPa] | | | | | | | |
| Absorbed energy | −30° C. | 1.1 | 1.5 | 4 | 0.3 | 0.7 | 1.7 |
| [J] | 23° C. | 12 | 11 | 13 | 10 | 9 | 9 |
| | 60° C. | 9 | 8 | 11 | 8 | 9 | 8 |
| | Mode of fracture | Brittle | Brittle | Brittle | Brittle | Brittle | Brittle |
| | at −30° C. | fracture | fracture | fracture | fracture | fracture | fracture |
| Critical strain | Kerosine | >0.7 | >0.7 | >0.7 | >0.7 | >0.7 | >0.7 |
| value [%] | | | | | | | |

TABLE 3

| | | | Reference |
|---|---|---|---|
| Component | Trade name | | Example 1 |
| (A) Styrene resin | HT478 | (weight part) | 60 |
| | 685 | (weight part) | 15 |
| (B) Propylene resin | EC9 | (weight part) | 10 |
| (C) Ethylene rubber | EG8100 | (weight part) | — |
| Styrene-conjugated diene | TR125 | (weight part) | 15 |
| block copolymer | | | |
| (D) Hydrogenated styrene- | H1043 | (weight part) | 8 |
| conjugated diene block | | | |
| copolymer | | | |
| Flexural modulus [MPa] | 60° | C. | 1500 |
| Absorbed energy [J] | −30° | C. | 16 |
| | 23° | C. | 14 |
| | 60° | C. | 13 |
| | Mode of fracture at −30° C. | | Ductile |
| | | | fracture |
| Absorbed energy after | −30° | C. | 7 |

| | | |
|---|---|---|
| extrusion of 8 times [J] | Mode of fracture | Brittle |
| | | fracture |
| Critical strain value [%] | Kerosine | >0.7 |

### INDUSTRIAL APPLICABILITY

The molded articles obtained using the thermoplastic resin composition of the present invention have excellent impact strength in a wide temperature range, are not brittle-fractured, and are excellent in chemical resistance. Therefore, they can be suitably used in the places where temperatures sharply change or under severe conditions, for example, as industrial members such as of houses, automobiles, etc.

1. A thermoplastic resin composition comprising (A) a rubber-modified styrene resin, (B) a propylene resin, (C) an ethylene rubber, and (D) a hydrogenated styrene-conjugated diene block copolymer, wherein
the hydrogenated styrene-conjugated diene block copolymer (D)is contained in an amount of 5-20 parts by weight based on 100 parts by weight in total of the rubber-modified styrene resin (A), the propylene resin (B), and the ethylene rubber (C);
the component (B) and the component (C) are dispersed in the styrene resin which is a continuous phase of the component (A) separately from the rubber particles originating from the component (A); and
the components (A), (B) and (C) satisfy the following formulas (1) and (2):
0<WB/WC<0.9 (formula (1)),
and
0.1<(WB+WC)/(WA+WB+WC)<0.5 (formula (2))
(wherein WA represents the weight proportion of the rubber-modified styrene resin (A) in the thermoplastic resin composition, WB represents the weight proportion of the propylene resin (B) in the thermoplastic resin composition, and WC represents the weight proportion of the ethylene rubber (C) in the thermoplastic resin composition).

2. The thermoplastic resin composition according to claim 1, wherein the components (A), (B) and (C) satisfy the following formulas (3) and (4):
0.2<WB/WC<0.8 (formula (3),
and
0.15<(WB+WC)/(WA+WB+WC)<0.35 (formula (4))
(wherein WA represents the weight proportion of the rubber-modified styrene resin (A) in the thermoplastic resin composition, WB represents the weight proportion of the propylene resin (B) in the thermoplastic resin composition, and WC represents the weight proportion of the ethylene rubber (C) in the thermoplastic resin composition).

3. The thermoplastic resin composition according to claim 1, wherein the styrene content in the hydrogenated styrene-conjugated diene block copolymer (D) is 60-80% by weight and the hydrogenation degree is 50% or more.

4. The thermoplastic resin composition according to claim 1, wherein the ethylene rubber (C) is a copolymer of ethylene and an α-olefin of 4-10 carbon atoms.

5. The thermoplastic resin composition according to claim 1, wherein the ethylene rubber (C) is an ethylene-α-olefin copolymer having a density of 0.84-0.91 g/cm³.

6. The thermoplastic resin composition according to claim 1, wherein the rubber-modified styrene resin (A) contains 3-12% by weight of a rubber-like polymer.

7. The thermoplastic resin composition according to claim 1, which has a peak of loss tangent, tan δ in the range of from −70° C. to −40° C. in measurement of dynamic viscoelasticity.

8. The thermoplastic resin composition according to claim 1, wherein the total amount of styrene monomer and ethylbenzene in the composition is 500 ppm or less.

9. The thermoplastic resin composition according to claim 1, wherein the disperse phases comprising the propylene resin (B) and the ethylene rubber (C) have an average longer diameter L of 0.5-10 μm, and have a ratio L/D of the average longer diameter L and the average shorter diameter D of 1.1 or more.

10. A molded article obtained by molding the thermoplastic resin composition according to claim 1, wherein the disperse phases comprising the propylene resin (B) and the ethylene rubber (C) have an average longer diameter L of 0.5-10 μm, and have a ratio L/D of the average longer diameter L and the average shorter diameter D of 1.1 or more.

11. The thermoplastic resin composition according to claim 2, wherein the styrene content in the hydrogenated styrene-conjugated diene block copolymer (D) is 60-80% by weight and the hydrogenation degree is 50% or more.

12. The thermoplastic resin composition according to claim 11, wherein the ethylene rubber (C) is a copolymer of ethylene and an α-olefin of 4-10 carbon atoms.

13. The thermoplastic resin composition according to claim 12, wherein the ethylene rubber (C) is an ethylene-α-olefin copolymer having a density of 0.84-0.91 g/cm³.

14. The thermoplastic resin composition according to claim 13, wherein the rubber-modified styrene resin (A) contains 3-12% by weight of a rubber-like polymer.

15. The thermoplastic resin composition according to claim 14 which has a peak of loss tangent, tan δ in the range of from −70° C. to −40° C. in measurement of dynamic viscoelasticity.

16. The thermoplastic resin composition according to claim 15, wherein the total amount of styrene monomer and ethylbenzene in the composition is 500 ppm or less.

17. The thermoplastic resin composition according to claim 16, wherein the disperse phases comprising the propylene resin (B) and the ethylene rubber (C) have an average longer diameter L of 0.5-10 μm, and have a ratio L/D of the average longer diameter L and the average shorter diameter D of 1.1 or more.

18. A molded article obtained by molding the thermoplastic resin composition according to claim 17, wherein the disperse phases comprising the propylene resin (B) and the ethylene rubber (C) have an average longer diameter L of 0.5-10 μm, and have a ratio L/D of the average longer diameter L and the average shorter diameter D of 1.1 or more.
